(19) United States
(12) Patent Application Publication
(10) Pub. No.: US 2007/0057803 A1
(43) Pub. Date: Mar. 15, 2007

(54) Projection television receiver having a projection lamp life indicator

(75) Inventors: Peter Severeijns, Powell, TN (US); Tom Kiewitt, Sevierville, TN (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC N.V., Eindhoven (NL)

(21) Appl. No.: 10/586,933

(22) PCT Filed: Jan. 27, 2005
(86) PCT No.: PCT/IB05/50367

§ 371 Date: Jul. 24, 2006

Related U.S. Application Data
(60) Provisional application No. 60/540,640, filed on Jan. 30, 2004.

(51) Int. Cl. G08B 21/00

(52) U.S. Cl. 340/641

(57) ABSTRACT

A rear projection television receiver includes an arrangement for detecting impending light source failure. The arrangement detects an electrical parameter of the ligth source and compares this detected parameter with a predetermined threshold level. When the detected parameter exceeds this threshold level, the arrangement advises the user to replace the light source.

The subject invention relates to projection television receivers having a light source in the form of a lamp.

Projection type television receivers have been known and developed for many years. Typically, projection television receivers are formed by a video signal applied to three cathode ray tubes which are driven as a light source. The light signal from these CRT's is then focused by projection lenses and projected either to an external screen, or onto the back of a rear projection screen.

The weak link in such projection television receivers is the cathode ray tubes. Besides being heavy in weight, these cathode ray tubes are relatively expensive to replace. Further, there are limitations as to the quality of the projected image attainable from the cathode ray tubes.

Advancements in projection television receivers have led to the development of liquid crystal panels for modulating a light beam projected through the panel, in which the liquid crystal panel is energized by the video signal. In one of these types projection television receivers, separate red, green and blue light beams are projected through three respective liquid crystal panels which receive the three red, green and blue video signals. The modulated light beams are then projected to the projection screen. In another of these types of projection television receivers, a single liquid crystal panel is sequentially illuminated by a red, green and blue light beam, the liquid crystal panel being sequentially driving by the red, green and blue video signals. In yet another type of projection television receiver, the liquid crystal panel is replaced by a deformable mirror device in which a plurality of miniature mirrors are arranged in a panel and each mirror is selectively deformed in dependence on the applied video signal. In a still further type of projection television receiver, a reflective liquid crystal on silicon (LCOS) panel is used to selectively reflect light.

In each of these types of projection television receiver, a lamp-type light source is used to generate the red, green and blue light beams by passing the white light from the light source through a prism. Now, the “weak link” is the lamp-type light source which, upon failure, causes the projection television receiver to cease operating.

In order to prevent the light source from failing at an inopportune time, U.S. Pat. No. 6,268,799 discloses an arrangement for measuring the amount of time that the light source has been operating. When the operating time approaches that which is determined to be the life of the light source, a warning is given to the user that lamp replacement is necessary. However, this arrangement then causes the user to replace a lamp while it still may have some useful life left.

Japanese Patent Publication JP07281146 discloses a liquid crystal projection television receiver in which a light sensor is positioned to detect the light being emitted by the light source. When the quantity of light detected by the light sensor drops below a particular level, a warning is displayed advising that the light source should be replaced.

However, this type system is prone to erroneous signals in that the accumulation of dirt on the light sensor, or the failure of the light sensor itself may lead to false warnings.

It is an object of the invention to provide an arrangement for a projection television receiver which can timely and reliably alert a user of impending light source failure.

This object is achieved in an arrangement for detecting impending light source failure in a projection television receiver, said arrangement comprising means for measuring an electrical parameter of a light source in a projection television receiver; means for comparing said measured electrical parameter with a predetermined amount; and means for generating a signal when said comparing means indicates that said measured electrical parameter passes said predetermined amount.

Generally, mercury arc lamps are used in projection television receivers. Applicants have found that as the lamp ages, the gap between the electrodes in the lamp changes requiring a compensation of the lamp voltage, current and/or frequency to maintain lamp power. This continues until the lamp fails. By determining the lamp arc voltage, current and/or frequency level of the lamp just prior to failure, this level may be set as a threshold. As such, the arrangement of the subject invention monitors the lamp arc voltage, current and/or frequency applied to the lamp. When the lamp arc voltage, current and/or frequency level approaches the threshold level, the arrangement then signals the user to replace the lamp. This then avoids premature replacement of the lamp.

With the above and additional objects and advantages in mind as will hereinafter appear, the invention will be described with reference to the accompanying drawings, in which:

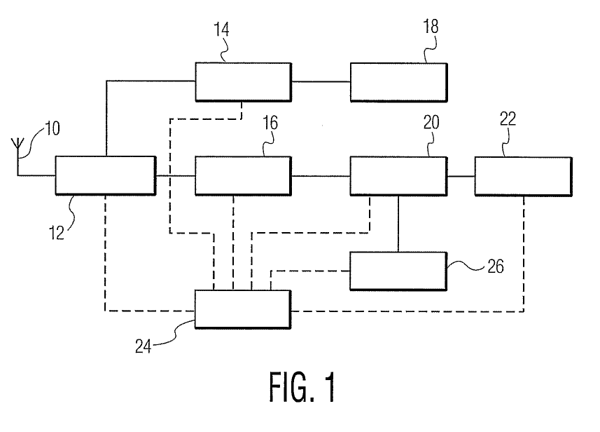

FIG. 1 shows a block schematic diagram of a rear projection television receiver;

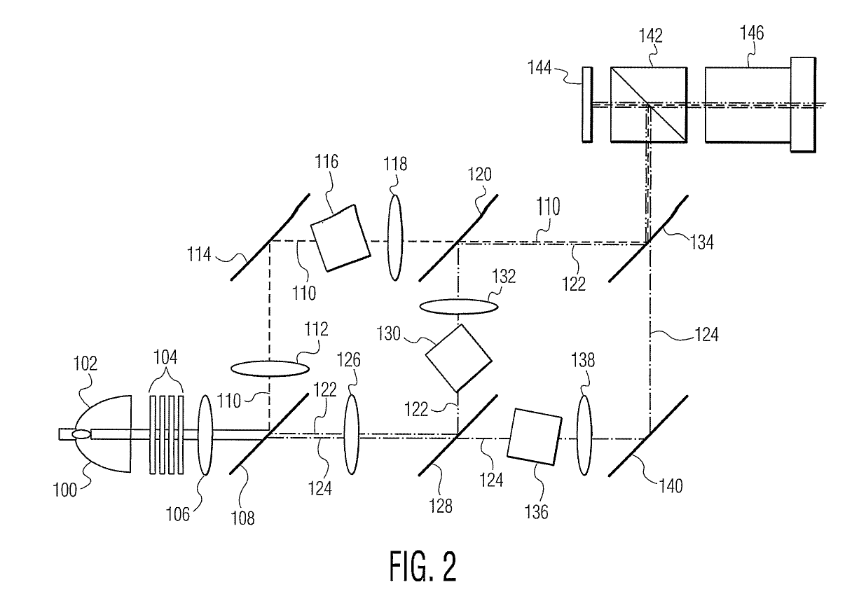

FIG. 2 shows the light engine in a single panel LCOS rear projection television receiver; and

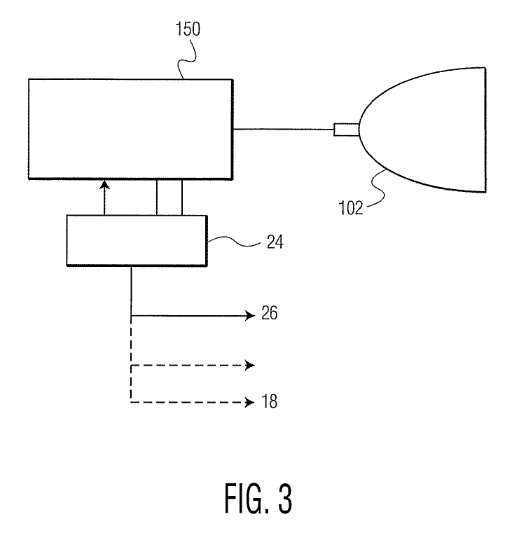

FIG. 3 shows a block schematic diagram of the arrangement of the subject invention.

FIG. 1 shows a block circuit diagram of a rear projection television receiver. An antenna 10 applies television signals to a tuner 12. While antenna 10 is shown, it should be understood that the television signals may originate from a variety of sources, including cable, satellite receiver, video tape, DVD, etc. The tuner 12 selects one of the television signals and applies the audio portion to audio signal processor 14, and the video portion to video signal processor 16. The audio signal processor 14 applies audio signals to the audio amplifiers and loudspeakers 18 for forming an audible sound. The video signal processor 16 applies video signals to a video switch 20 which applies video driving signals to the video drive circuit and display 22. A microprocessor 24 is included and applies control signals to the tuner 12, the audio signal processor 14, the video signal processor 16, the video switch 20 and the video drive circuits and display 22. In order to display messages, for example, time and the current channel, the rear projection television receiver includes an On-Screen Display (OSD) processor 26 which, under control of the microprocessor 24, applies video signals to the video switch 20.

FIG. 2 shows a diagram of a light engine for an LCOS projection television receiver. A light beam 100 from a mercury arc lamp 102 passes through an array of optical filters and integrators 104 and collimator lens 106 to a dichroic mirror 108. This dichroic mirror is arranged to reflect red light rays while passing all other color light rays (green and blue). The red light rays 110 then pass through a relay lens 112 and are reflected off a mirror/color filter 114. The reflected red light rays 110 then pass through a scanning prism 116, a relay lens 118 and on to a dichroic mirror 120.

The green and blue light rays 122 and 124, which pass through the dichroic mirror 108, pass through a relay lens 126 to a dichroic mirror 128 which is arranged to reflect the green light rays 122 while passing the blue light rays 124. The green light rays then pass through a scanning prism 130 and a relay lens 132 to the dichroic mirror 120, which is arranged to pass the red light rays 110 while reflecting the green light rays 122. The red and green light rays 110 and 122 then proceed to dichroic mirror 134.

The blue light rays 124, which pass through the dichroic mirror 128, then pass through a scanning prism 136 and a relay lens 138 to a mirror 140, and proceed onward to the dichroic mirror 134 which is arranged to pass the blue light rays 124 while reflecting the red and green light rays 110 and 122.

The scanning prisms 116, 130 and 136 cause the respective red, green and blue light rays 110, 122 and 124 to form color bars which are repeatedly scanned, for example, from top to bottom (alternatively, from bottom to top, right to left, or left to right, as required). The red, green and blue light rays 110, 122 and 124 then encounter a polarizing beam-splitter (PBS) 142 which directs the polarized beam onto the LCOS panel 144 from which the reflected image is passed by the PBS 142 and projected by projection lens 146 to a rear projection screen (not shown).

FIG. 3 shows a block circuit diagram of the lamp driving circuit. In particular, the lamp 102 is a mercury arc lamp and receives a drive voltage at a particular current from the lamp driver 150. In order to maintain the integrity of the lamp 102, it is necessary that the power applied to the lamp 102 remains constant. To that end, microprocessor 24 monitors the voltage, current and/or frequency applied to the lamp 102 by the lamp driver 150. As the lamp 102 ages, the gap between its electrodes changes and as such, the lamp power changes. The microprocessor 24 detects this change in power and controls the lamp driver 150 to compensate the arc voltage, current and/or frequency in order to keep the lamp power constant. When the microprocessor 24 detects that the lamp arc voltage, current and/or frequency reaches a predetermined level indicative of the life of the lamp, the microprocessor 24 applies an appropriate signal to the OSD processor 26 and the video switch 20 such that a message may be given to the user of the rear projection television receiver to replace the lamp 102. Alternatively, the microprocessor 24 may activate an LED indicator (not shown) or another means of visual identification, or provide a warning signal to the loudspeakers 18. The microprocessor 24 may also provide information to the OSD processor 26 to display information with respect to the expected life of the lamp.

Numerous alterations and modifications of the structure herein disclosed will present themselves to those skilled in the art. However, it is to be understood that the above described embodiment is for purposes of illustration only and not to be construed as a limitation of the invention. All such modifications which do not depart from the spirit of the invention are intended to be included within the scope of the appended claims.

1. An arrangement for detecting impending light source failure in a projection television receiver, said arrangement comprising:
means for measuring (150) an electrical parameter of a light source (102) in a projection television receiver;
means for comparing (24) said measured electrical parameter with a predetermined amount; and
means for generating (24) a signal when said comparing means indicates that said measured electrical parameter exceeds said predetermined amount.

2. The arrangement as claimed in claim 1, wherein said measuring means (150) measures an arc voltage supplied to said light source (102).

3. The arrangement as claimed in claim 1, wherein said generating means (24) comprises means for illuminating a warning light for alerting a user of the projection television receiver.

4. The arrangement as claimed in claim 1, wherein said generating means (24) comprises means for activating an on-screen display (26) message for the user of the projection television receiver.

5. The arrangement as claimed in claim 1, wherein said comparing means (24) comprises:
means for generating a signal indicative of said predetermined amount; and
a comparator for comparing said measured electrical parameter to said predetermined amount.
